(19) United States
(12) Patent Application Publication
(10) Pub. No.: US 2006/0056512 A1
(43) Pub. Date: Mar. 16, 2006

(54) Video encoding method and corresponding computer programme

(75) Inventor: Eric Barrau, Puteaux (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/538,111

(22) PCT Filed: Dec. 5, 2003
(86) PCT No.: PCT/IB03/05766

§ 371 Date: Jun. 8, 2005

(30) Foreign Application Priority Data
Dec. 11, 2002 (EP) 02293062.2
Dec. 18, 2002 (EP) 02293132.3

(51) Int. Cl. H04N 11/02; H04N 11/04; H04N 7/12; H04B 1/66

(52) U.S. Cl. 375/240.16; 375/240.11; 375/240.12

(57) ABSTRACT

The invention relates to a method of encoding a sequence of frames, composed of picture elements (pixels), by means of a three-dimensional (3D) subband decomposition involving a filtering step applied, in the sequence considered as a 3D volume, to the spatial-temporal data which correspond in said sequence to each one of successive groups of frames (GOFs), and to implementations of said method. The GOFs are themselves subdivided into successive pairs of frames (POFs) including a so-called previous frame and a so-called current frame, and the decomposition is applied to said GOFs together with motion estimation and compensation steps performed in each GOF on saids POFs and on corresponding pairs of low-frequency temporal subbands (POSs) obtained at each temporal decomposition level. The process of motion compensated temporal filtering leading in the previous frames on the one hand to connected pixels, that are filtered along a motion trajectory corresponding to motion vectors defined by means of said motion estimation steps, and on the other hand to a residual number of so-called unconnected pixels, that are not filtered at all, each motion estimation step comprises a motion search provided for returning a motion vector that minimizes a cost function depending at least on a distorsion criterion, said criterion taking into account the unconnected pixels phenomenon for the minimizing operation, itself based on specific rules allowing to obtain, either by a non-recursive or a recursive implementation, the optimal set of motion vectors.

The present invention generally relates to the field of data compression and, more specifically, to a method of encoding a sequence of frames, composed of picture elements (pixels), by means of a three-dimensional (3D) subband decomposition involving a filtering step applied, in the sequence considered as a 3D volume, to the spatial-temporal data which correspond in said sequence to each one of successive groups of frames (GOFs), these GOFs being themselves subdivided into successive pairs of frames (POFs) including a so-called previous frame and a so-called current frame, said decomposition being applied to said GOFs together with motion estimation and compensation steps performed in each GOP on saids POFs and on corresponding pairs of low-frequency temporal subbands (POSs) obtained at each temporal decomposition level.

The invention also relates to a computer programme comprising a set of instructions for the implementation of said encoding method, when said programme is carried out by a processor included in an encoding device.

In recent years, three-dimensional (3D) subband analysis, based on a 3D, or (2D+t), wavelet decomposition of a sequence of frames considered as a 3D volume has been more and more studied for video compression. The wavelet transform generates coefficients that constitute a hierarchical pyramid in which the spatio-temporal relationship is defined thanks to 3D orientation trees evidencing the parent-offspring dependencies between said coefficients. The in-depth scanning of the generated coefficients in the hierarchical trees and a progressive bitplane encoding technique then lead to a desired quality scalability.

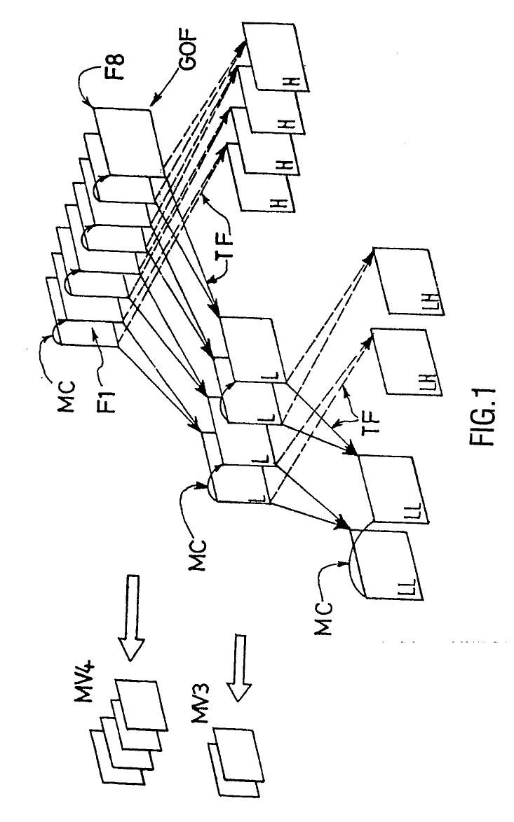

A practical solution for implementing this approach is to generate motion compensated temporal subbands using a simple two taps wavelet filter, as illustrated in FIG. 1 for a GOF of eight frames. In the illustrated implementation, the input video sequence is divided into Groups of Frames (GOFs), and each GOF, itself subdivided into successive couples of frames (that are as many inputs for a so-called Motion-Compensated Temporal Filtering, or MCTF module), is first motion-compensated (MC) and then temporally filtered (TF). The resulting low frequency (L) temporal subbands of the first temporal decomposition level are further filtered (TF), and the process may stop after an arbitrary number of decompositions resulting in one or more low frequency subbands called root temporal subbands (in the illustration, a non-limitative example with two decomposition levels resulting in two root subbands LL is presented). In the example of FIG. 1, the frames of the illustrated group are referenced F1 to F8, and the dotted arrows correspond to a high-pass temporal filtering, while the other ones correspond to a low-pass temporal filtering. Two stages of decomposition are shown (L and H=first stage; LL and LH=second stage). At each temporal decomposition level of the illustrated group of 8 frames, a group of motion vector fields is generated (in the present example, MV4 at the first level and MV3 at the second one).

When a Haar multiresolution analysis is used for the temporal decomposition, since one motion vector field is generated between every two frames in the considered group of frames at each temporal decomposition level, the number of motion vector fields is equal to half the number of frames in the temporal subband, i.e. four at the first level of motion vector fields and two at the second one. Motion estimation (E) and motion compensation (MC) are only performed every two frames of the input sequence (generally in the forward way), due to the temporal down-sampling by two of the simple wavelet filter. Using these very simple filters, each low frequency temporal subband (L) represents a temporal average of the input couples of frames, whereas the high frequency one (H) contains the residual error after the MCTF step.

Unfortunately, the motion compensated temporal filtering may raise the problem of unconnected pixels, which are not filtered at all (or also the problem of double-connected pixels, which are filtered twice). The number of unconnected pixels represents a weakness of a 3D subband codec approaches because it highly impacts the resulting picture quality, particularly in occlusion regions. It is especially true for high motion sequences or for final temporal decomposition levels, where the temporal correlation is not good. The number of these unconnected pixels depends on the dense motion vector field that has been generated by the motion estimation.

Current criteria for optimal motion vector search used in motion estimators do not take into account the number of unconnected pixels that will be the result of motion compensation. Most sophisticated algorithms use a rate/distortion criterion which tends to minimize a cost function that depends on the displaced difference energy (distortion) and the number of bits spent to transmit the motion vector (rate). For example, the motion search returns the motion vector that minimizes:
J(m)=SAD(s,c(m))+λ_{MOTION}·R(m−p) (1)

In this expression (1), m=(mₓ, m_{y})^{T} is the motion vector, p=(pₓ, p_{y})^{T} is the prediction for the motion vector, and λ_{MOTION} is the Lagrange multiplier. The rate term R(m−p) represents the motion information only and SAD, used as distortion measure, is computed as:

$$SAD ( s , c ( m ) ) = {\sum }_{x = 1 , y = 1}^{B , B} \vert s [ x , y ] - c [ x - {m}_{x} , y - {m}_{y} ] \vert \qquad ( 2 )$$

with s being the original video signal, c being the coded video signal and B being the block size (note that B can be 1). Unfortunately, these algorithms do not take into account the distortion introduced by unconnected pixels during the inverse motion compensation because usually these optimizations are applied to hybrid coding for which the inverse motion compensation is not performed.

It is therefore an object of the invention to avoid such a drawback and to propose a video encoding method in which the set of unconnected pixels is taken into account in the distortion measure.

To this end, the invention relates to a method such as defined in the introductory paragraph and which is moreover characterized in that, said process of motion compensated temporal filtering leading in the previous frames on the one hand to connected pixels, that are filtered along a motion trajectory corresponding to motion vectors defined by means of said motion estimation steps, and on the other hand to a residual number of so-called unconnected pixels, that are not filtered at all, each motion estimation step comprises a motion search provided for returning a motion vector that minimizes a cost function depending at least on a distorsion criterion involving a distortion measure, said measure distorsion being also applied to the set of said unconnected pixels.

The present invention will now be described, by way of example, with reference to the accompanying drawing in which FIG. 1 shows a temporal multiresolution analysis with motion compensation.

Because unconnected pixels highly participate to the quality degradation of the inverse motion compensated image, the set of unconnected pixels is, according to the invention, taken into account in the distortion measure. To this end, it is here proposed to introduce a new rate/distortion criterion that extends equation taking into account the unconnected pixels phenomenon. This is illustrated in equations (3) and (4), that are equivalent:
K(m)=J(m)+λ_{UNCONNECTED}·D(S_{UNCONNECTED}(m)) (3)
K(m)=SAD(s,c(m))+λ_{UNCONNECTED}·D(S_{UNCONNECTED}(m))+λMOTION·R(m−p) (4)
with D(S_{UNCONNECTED}(m)) being the distortion measure for the set S_{UNCONNECTED} of unconnected pixels resulting from motion vector m. Several distortion measures can be applied to the set of unconnected pixels. A very simple measure is preferably the count of unconnected pixels for the motion vector under study.

It can be noted that the real set of unconnected pixels resulting from a motion search can be computed only when the motion vectors information is available for the whole frame. Therefore, an optimal solution can hardly be achievable (in fact a complex set of minimisation criteria for the whole frame should be solved), and a sub-optimal implementation is therefore proposed. This implementation, not recursive, can be considered as a simple way to take into account the distortion due to unconnected pixels. For a given part of the image to be motion compensated (a part of the image can be a pixel, a block of pixels, a macroblock of pixels or any region provided that the set of parts covers the whole image without any overlapping) and for a given motion vector candidate m, a temporary inverse motion compensation is applied, the set of unconnected pixels is identified, and D(S_{UCONNECTED}(m)) can be evaluated. The current K(m) value can then be computed and compared to the current minimum value Kₘᵢₙ(m) to check if the candidate motion vector brings a lower K(m) value (for the first motion vector candidate, K(m) is obviously equal to the valeur K(m) computed). When all the candidate have been tested, the (final) inverse motion compensation is applied to the best candidate (identifying connected and unconnected pixels). The next part of the image can then be processed, and so on up to a complete processing of the whole image.

However, in this non-recursive implementation, the resulting decisions are not always spatially homogeneous over the whole image: for the first part of the image to be motion compensated, the set of unconnected pixels may be empty, while the probability of unconnected pixels for the last part of the image to be motion compensated is then very high. This situation can lead to heterogeneous spatial distorsions. In order to discard such a problem, resulting of the single-pass implementation, a multiple-pass implementation can be proposed, which indeed allows to improve said single-pass one by minimizing the global criterion Σ K(m) for all parts of the whole image, which can be done with a multiple-pass implementation including the following steps.

First, for all the parts of the image, the optimal motion vector mₒₚₜ is computed, as well as a set of N_{sub-opt} sub-optimal motion vectors {m_{sub-opt}} that provide the minimum values for J(m) of equation (1), the number of unconnected pixels being not used at this stage (the number of sub-optimal vectors N_{sub-opt} is implementation dependent). For all these vectors, the corresponding value for the criterion J(m) is stored so that J(mₒₚₜ) and {J(m_{sub-opt})} are generated. Then an inverse motion compensation is applied for the optimal motion vectors mₒₚₜ so that

$${\sum }_{all parts} K ( {m}_{opt} )$$

can be computed (note that

$${\sum }_{all parts} K ( {m}_{opt} )$$

is not the optimal value for

$${\sum }_{all parts} K ( m ) ,$$

because mₒₚₜ is optimizing J(m) and not K(m)). From the list of sub-optimal vectors, the candidate motion vector m_{candidate} minimizing |{J(mₒₚₜ)}−{J(m_{candidate})}| is then selected (note that m_{candidate} can be a vector of any part of the current image). For the set of optimal motion vectors and the candidate vector (in place of the optimal vector for the corresponding part of the image), an inverse motion compensation is applied and

$${\sum }_{all parts} K ( m )$$

is again computed. If its value is lower than

$${\sum }_{all parts} K ( {m}_{opt} ) ,$$

the optimal value of mₒₚₜ is replaced by m_{candidate} (for the corresponding part of the image). Finally m_{candidate} is discarded from the list of sub-optimal vectors. Then a new candidate is selected and the same mechanism is applied until the list of sub-optimal vectors is empty, in order to obtain the optimal set of motion vectors.

1. A method of encoding a sequence of frames, composed of picture elements (pixels), by means of a three-dimensional (3D) subband decomposition involving a filtering step applied, in the sequence considered as a 3D volume, to the spatial-temporal data which correspond in said sequence to each one of successive groups of frames (GOFs), these GOFs being themselves subdivided into successive pairs of frames (POFs) including a so-called previous frame and a so-called current frame, said decomposition being applied to said GOFs together with motion estimation and compensation steps performed in each GOF on saids POFs and on corresponding pairs of low-frequency temporal subbands (POSs) obtained at each temporal decomposition level, this process of motion compensated temporal filtering leading in the previous frames on the one hand to connected pixels, that are filtered along a motion trajectory corresponding to motion vectors defined by means of said motion estimation steps, and on the other hand to a residual number of so-called unconnected pixels, that are not filtered at all, each motion estimation step comprising a motion search provided for returning a motion vector that minimizes a cost function depending at least on a distorsion criterion involving a distortion measure, said measure distorsion being also applied to the set of said unconnected pixels.

2. An encoding method according to claim 1, in which said motion search is provided for returning the motion vector that minimizes the following expression (1):
J(m)=SAD(s,c(m))+λ_{MOTION}·R(m−p) (1)
where m=(mₓ, m_{y})T is the motion vector, p=(pₓ, p_{y})^{T} is the prediction for the motion vector, λ_{MOTION} is the Lagrange multiplier, the rate term R(m−p) represents the motion information only, SAD used as distortion measure is computed as:
$$SAD ( s , c ( m ) ) = {\sum }_{x = 1 , y = 1}^{B , B} \vert s [ x , y ] - c [ x - {m}_{x} , y - {m}_{y} ] \vert \qquad ( 2 )$$
s is the original video signal, c is the coded video signal and B is the block size, characterized in that the distorsion criterion extends equation (1), taking into account the unconnected pixels phenomenon for the minimizing operation that is applied to the following expression (3):
K(m)=J(m)+λ_{UNCONNECTED}·D(S_{UNCONNECTED}(m)) (3)
in which D(S_{UNCONNECTED}(m)) is the distortion measure for the set S_{UNCONNECTED} of unconnected pixels resulting from the motion vector m.

3. An encoding method according to claim 2, characterized in that it includes, for taking into account the distortion due to the unconnected pixels, the following steps, successively applied to each part of the whole image to be motion-compensated:
(a) for the considered part of the image and for a given motion vector candidate m, a temporary inverse motion compensation is applied;
(b) the set of unconnected pixels is identified;
(c) D(S_{UNCONNECTED}(m)) is evaluated;
(d) the current K(m) value is computed and compared to the current minimum value Kₘᵢₙ(m) to check if the motion vector candidate brings a lower K(m) value;
(e) when all the candidates have been tested, a final inverse motion compensation is applied to the best candidate;
(f) the steps (a) to (e) are then applied to the next part of the image that can be similarly processed, said part of the image being a pixel, a block of pixels, a macroblock of pixels or any region provided that the set of parts covers the whole image without any overlapping.

4. An encoding method according to claim 2, characterized in that it includes, for taking into account the distortion due to the unconnected pixels and minimizing the global criterion Σ [all parts]K(m) for the whole image to be compensated, the following steps:
(a) the optimal motion vector mₒₚₜ is computed, as well as a set of N_{sub-opt} sub-optimal motion vectors {m_{sub-opt}} that provide the minimum values for J(m);
(b) for all these vectors, the corresponding value for the criterion J(m) is stored, in order to generate J(mₒₚₜ) and {J(mₛᵤₚ₋ₒₚₜ};
(c) an inverse motion compensation is applied for the optimal motion vectors mₒₚₜ, in order to compute Σ [all parts]K(mₒₚₜ);
(d) from the list of sub-optimal vectors, the candidate motion vector m_{candidate} minimizing |{J(mₒₚₜ}−{J(m_{candidate})}| is selected;
(e) for the set of optimal motion vectors and the candidate vector, an inverse motion compensation is applied, in order to compute again Σ [all parts]K(m);
(f) if the value of Σ [all parts]K(m) is lower than Σ [all parts]K(mₒₚₜ), the optimal value of mₒₚₜ is replaced by m_{candidate}, for the corresponding part of the image;
(g) finally, m_{candidate} is discarded from the list of sub-optimal vectors;
(h) a new candidate is selected, and the same mechanism is then applied until the list of sub-optimal vectors is empty, in order to obtain the optimal set of motion vectors.

5. A computer programme comprising a set of instructions for the implementation of a method according to claim 3, when said programme is carried out by a processor included in an encoding device.
